(19) United States
(12) Patent Application Publication
(10) Pub. No.: US 2008/0284912 A1
(43) Pub. Date: Nov. 20, 2008

(54) Display and Television

(75) Inventor: Tadahiro NAITO, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/120,929

(22) Filed: May 15, 2008

(30) Foreign Application Priority Data
May 15, 2007 (JP) 2007-129195

(51) Int. Cl. H04N 3/27; H04N 5/66

(52) U.S. Cl. 348/554; 348/739; 348/E05.133; 348/E03.049

(57) ABSTRACT

This display includes a detection portion detecting a signal from an external apparatus connected to an external input connection portion, a display portion selectably displaying an input mode corresponding to the external input connection portion and a control portion controlling the display portion to display an image on the basis of a signal of the external input connection portion corresponding to the selected input mode. The display selectably displays a first input mode corresponding to the external input connection portion from which a signal is detected by the detection portion, and selectably displays a second input mode corresponding to at least an external input connection portion from which no signal is detected by the detection portion when the first input mode is not selected.

### BACKGROUND OF THE INVENTION

1. Field of the Invention

The present invention relates to a display and a television, and more particularly, it relates to a display and a television each comprising a plurality of external input connection portions connected with a plurality of external apparatuses respectively.

2. Description of the Background Art

A display comprising a plurality of external input connection portions connected with a plurality of external apparatuses respectively is known in general. This display is so formed as to enable the user to switchingly select an input mode from input modes corresponding to a plurality of external input terminals respectively thereby displaying images received from an external apparatus connected to the external input terminal corresponding to the selected input mode on a display portion. In this display, however, the user must sequentially switch the plurality of input modes one by one by a prescribed operation, and hence time is disadvantageously required for switching the input modes.

Therefore, a display comprising a structure for solving the aforementioned problem is proposed in general, as disclosed in each of Japanese Patent Laying-Open Nos. 2006-254033, 2001-8115, 5-207386 (1993) and 10-262190 (1998), for example.

The display described in each of the aforementioned Japanese Patent Laying-Open Nos. 2006-254033, 2001-8115 and 5-207386 detects the presence or absence of signals from external apparatuses connected to a plurality of external input terminals with a detection circuit or the like, and is so formed as to skip an input mode corresponding to an external input terminal from which no signal received from the corresponding external apparatus is detected when the user switches the input mode. Thus, the user can switch the input mode in a short time.

The display described in the aforementioned Japanese Patent Laying-Open No. 10-262190 is so formed that the user registers an external input terminal, included in a plurality of external input terminals, connected with no external apparatus to the display, thereby skipping an input mode corresponding to the registered external input terminal when switching the input mode. Thus, the user can switch the input mode in a short time.

However, the display described in each of the aforementioned Japanese Patent Laying-Open Nos. 2006-254033, 2001-8115 and 5-207386 skips the input mode corresponding to the external input terminal from which no video signal is detected since no external apparatus is connected thereto or the external apparatus connected thereto is in an OFF-state when the user switches the input mode, and hence the user cannot select the input mode corresponding to this external input terminal. Therefore, the user cannot select the input mode corresponding to this external input terminal unless he/she connects an ON-state external apparatus to the external input terminal.

In the display described in the aforementioned Japanese Patent Laying-Open No. 10-262190, the user must previously set the skipped input mode, and hence the display is disadvantageously inferior in convenience.

### SUMMARY OF THE INVENTION

The present invention has been proposed in order to solve the aforementioned problems, and an object of the present invention is to provide a display and a television each having an excellent convenience and enabling the user to select an input mode corresponding to an external connection portion without connecting an ON-state external apparatus to the external input connection portion.

A display according to a first aspect of the present invention comprises a plurality of external input connection portions connected with a plurality of external apparatuses respectively, a detection portion detecting signals from the external apparatuses connected to the external input connection portions, a display portion selectably displaying input modes corresponding to the plurality of external input connection portions respectively and a control portion controlling the display portion to display an image on the basis of a signal of the external input connection portion corresponding to a selected input mode, and the control portion is so formed as to control the display portion to selectably display a first input mode corresponding to the external input connection portion from which a signal is detected by the detection portion and to selectably display a second input mode corresponding to at least the external input connection portion from which no signal is detected by the detection portion when the first input mode is not selected.

In this display according to the first aspect, as hereinabove described, the display portion selectably displays the first input mode corresponding to the external input connection portion from which a signal is detected by the detection portion so that the user can display only the input mode (first input mode) corresponding to the external input connection portion from which the signal is detected on the display portion while automatically skipping the input mode (second input mode) corresponding to the external input connection portion from which no signal is detected with no separate setting, whereby the convenience of the user can be improved. Further, the display portion selectably displays the first input mode corresponding to the external input connection portion from which the signal is detected by the detection portion while selectably displaying the second input mode corresponding to at least the external input connection portion from which no signal is detected by the detection portion when the first input mode is not selected, whereby the user can also select the input mode (second input mode) corresponding to the external input connection portion from which no signal is detected since no external apparatus is connected thereto or the external apparatus connected thereto is in an OFF-state. Thus, the user can select the input mode corresponding to the external input connection portion without connecting an ON-state external apparatus to the external input connection portion.

In the aforementioned display according to the first aspect, the control portion may be so formed as to control the display portion to selectably display the first input mode corresponding to the external input connection portion from which a signal is detected by the detection portion and to selectably display both of the first input mode and the second input mode corresponding to the external input connection portion from which no signal is detected by the detection portion when the first input mode is not selected.

In this case, the display preferably further comprises an input portion allowing the user to switch and select the input mode, and the control portion is preferably so formed as to control the display portion to display both of the first input mode and the second input mode so that the user can successively switch and select the first input mode or the second input mode when the user further switches the input mode in a state selecting the terminal first input mode. According to this structure, the user can direct the display portion to selectively display the second input mode in addition to the first input mode by further switching the input mode in the state selecting the terminal first input mode when the first input mode includes no intended input mode.

The aforementioned display according to the first aspect preferably further comprises a registration portion registering the first input mode, and the control portion is preferably so formed as to register the selected second input mode as the first input mode when the second input mode is selected. According to this structure, the display portion can first display the registered input mode as the first input mode when the input mode is changed after registration.

The aforementioned display according to the first aspect preferably further comprises a receiving portion receiving a broadcast signal transmitted from a broadcast station, and the control portion is preferably so formed as to register the first input mode in the registration portion when registering a channel corresponding to the broadcast signal received by the receiving portion upon power supply to the display. According to this structure, an input mode corresponding to an external apparatus such as a cable TV tuner generally connected to the display in an ON-state can be substantially simultaneously registered when the channel is registered. Thus, the user can watch images received from the external apparatus such as the cable TV tuner immediately after registering the channel.

In this case, the control portion may be so formed as to control the detection portion to detect the signals from the external apparatuses connected to the external input connection portions and to control the registration portion to register the first input mode every time power is supplied to the display.

In the aforementioned structure comprising the receiving portion, the control portion is preferably so formed as to control the display portion to display an input mode corresponding to the receiving portion of the display as the first input mode. According to this structure, the control portion can control the display portion to first display the highly selectable input mode corresponding to the receiving portion of the display as the first input mode. Thus, the user can easily select the input mode corresponding to the receiving portion from the first input mode without directing the display portion to display the second input mode, thereby easily directing the display portion to display images based on the broadcast signal received in the receiving portion.

The aforementioned display according to the first aspect preferably further comprises a scaler adjusting the image to coincide with the size of a display section of the display portion, and the scaler is preferably so formed as to function also as the detection portion detecting the signals from the external apparatuses. According to this structure, the scaler can detect the signals from the external apparatuses, with no requirement for a circuit for detecting the signals from the external apparatuses.

A television according to a second aspect of the present invention comprises a plurality of external input connection portions connected with a plurality of external apparatuses respectively, a detection portion detecting signals from the external apparatuses connected to the external input connection portions, a display portion selectably displaying input modes corresponding to the plurality of external input connection portions respectively and a control portion controlling the display portion to display an image on the basis of a signal of the external input connection portion corresponding to a selected input mode, and the control portion is so formed as to control the display portion to selectably display a first input mode corresponding to the external input connection portion from which a signal is detected by the detection portion and to selectably display a second input mode corresponding to at least the external input connection portion from which no signal is detected by the detection portion when the first input mode is not selected.

In the television according to the second aspect, as hereinabove described, the display portion selectably displays the first input mode corresponding to the external input connection portion from which a signal is detected by the detection portion so that the user can display only the input mode (first input mode) corresponding to the external input connection portion from which a signal is detected on the display portion while automatically skipping the input mode (second input mode) corresponding to the external input connection portion from which no signal is detected with no separate setting, whereby the convenience of the user can be improved. Further, the display portion selectably displays the first input mode corresponding to the external input connection portion from which a signal is detected by the detection portion while selectably displaying the second input mode corresponding to at least the external input connection portion from which no signal is detected by the detection portion when the first input mode is not selected, whereby the user can also select the input mode (second input mode) corresponding to the external input connection portion from which no signal is detected since no external apparatus is connected thereto or the external apparatus connected thereto is in an OFF-state. Thus, the user can select the input mode corresponding to the external input connection portion without connecting an ON-state external apparatus to the external input connection portion.

In the aforementioned television according to the second aspect, the control portion may be so formed as to control the display portion to selectably display the first input mode corresponding to the external input connection portion from which a signal is detected by the detection portion and to selectably display both of the first input mode and the second input mode corresponding to the external input connection portion from which no signal is detected by the detection portion when the first input mode is not selected.

In this case, the television preferably further comprises an input portion allowing the user to switch and select the input mode, and the control portion is preferably so formed as to control the display portion to display both of the first input mode and the second input mode so that the user can successively switch and select the first input mode or the second input mode when the user further switches the input mode in a state selecting the terminal first input mode. According to this structure, the user can direct the display portion to selectively display the second input mode in addition to the first input mode by further switching the input mode in the state selecting the terminal first input mode when the first input mode includes no intended input mode.

The aforementioned television according to the second aspect preferably further comprises a registration portion registering the first input mode, and the control portion is preferably so formed as to register the selected second input mode as the first input mode when the second input mode is selected. According to this structure, the display portion can first display the registered input mode as the first input mode when the input mode is changed after registration.

The aforementioned television according to the second aspect preferably further comprises a receiving portion receiving a broadcast signal transmitted from a broadcast station, and the control portion is preferably so formed as to register the first input mode in the registration portion when registering a channel corresponding to the broadcast signal received by the receiving portion upon power supply to the television. According to this structure, an input mode corresponding to an external apparatus such as a cable TV tuner generally connected to the television in an ON-state can be substantially simultaneously registered when the channel is registered. Thus, the user can watch images received from the external apparatus such as the cable TV tuner immediately after registering the channel.

In this case, the control portion may be so formed as to control the detection portion to detect the signals from the external apparatuses connected to the external input connection portions and to control the registration portion to register the first input mode every time power is supplied to the television.

In the aforementioned structure comprising the receiving portion, the control portion is preferably so formed as to control the display portion to display an input mode corresponding to the receiving portion of the television as the first input mode. According to this structure, the control portion can control the display portion to first display the highly selectable input mode corresponding to the receiving portion of the television as the first input mode. Thus, the user can easily select the input mode corresponding to the receiving portion from the first input mode without directing the display portion to display the second input mode, thereby easily directing the display portion to display images based on the broadcast signal received in the receiving portion.

The aforementioned television according to the second aspect preferably further comprises a scaler adjusting the image to coincide with the size of a display section of the display portion, and the scaler is preferably so formed as to function also as the detection portion detecting the signals from the external apparatuses. According to this structure, the scaler can detect the signals from the external apparatuses, with no requirement for a circuit for detecting the signals from the external apparatuses.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a television according to an embodiment of the present invention;

FIG. 2 shows a list of registered input modes displayed on a display portion of the television according to the embodiment of the present invention;

FIG. 3 shows a list of standard input modes displayed on the display portion of the television according to the embodiment of the present invention;

FIG. 4 shows a list of additionally registered input modes displayed on the display portion of the television according to the embodiment of the present invention;

FIG. 5 is a flow chart for illustrating processing for detecting a video signal from an external apparatus in the television according to the embodiment of the present invention; and

FIG. 6 is a flow chart for illustrating an input mode switching operation in the television according to the embodiment of the present invention.

### DESCRIPTION OF THE PREFERRED EMBODIMENTS

An embodiment of the present invention is now described with reference to the drawings.

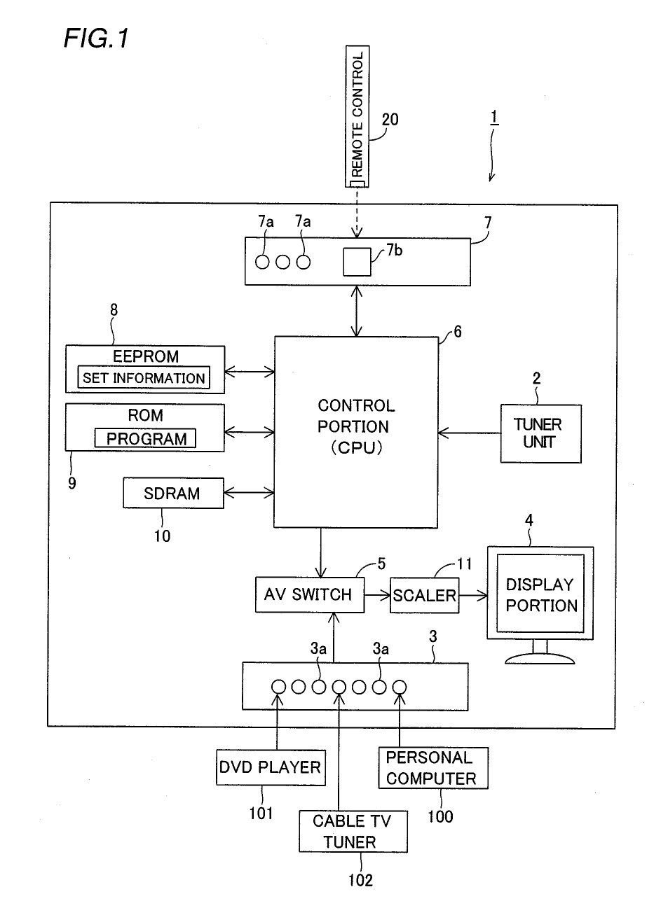

First, the structure of a television 1 according to this embodiment is described with reference to FIG. 1. This embodiment of the present invention is applied to the television 1 employed as an exemplary display.

As shown in FIG. 1, the television 1 comprises a tuner unit 2 including an antenna (not shown) receiving broadcast signals transmitted from broadcast stations, an external input substrate 3 including a plurality of external input terminals 3a connected with external apparatuses such as a personal computer 100, a DVD player 101 and a cable TV tuner 102, a display portion 4 formed by an LCD (liquid crystal display), an AV switch 5 selecting a specific video signal from among a plurality of video signals received from the tuner unit 2 and the external input substrate 3 and a control portion (CPU) 6 controlling the respective portions of the television 1. The television 1 further comprises an input portion 7 having a plurality of buttons 7a for changing the volume, the channel, set conditions etc. of the television 1. The input portion 7 includes a receiving portion 7b receiving a signal from a remote control 20. The user can also change the volume etc. with the remote control 20. Each signal received in the input portion 7 or transmitted from the remote control 20 is input in the control portion 6. The control portion 6 controls the respective potions of the television 1 to perform prescribed processing on the basis of the signal. The tuner unit 2 and the external input terminals 3a are examples of the “receiving portion” and the “external input connection portions” in the present invention respectively.

The tuner unit 2 is so formed as to detect and demodulate a broadcast signal, included in the broadcast signals received by the antenna (not shown), corresponding to a channel specified by the user and to output resulting data to the AV switch 5 through the control portion 6.

The display portion 4 displays images corresponding to a video signal input from the AV switch 5. The user can switch and select the video signal input from the AV switch 5 by performing a prescribed operation on the input portion 7 or the remote control 20. This selecting operation is described later in more detail.

The control portion 6 is so formed as to control the television 1 according to set information stored in an EEPROM 8 and programs stored in a ROM 9. The EEPROM 8 is an example of the “registration portion” in the present invention. The set information includes information as to the display on the display portion 4, for example. More specifically, the set information includes information as to parental control, information as to captions (subtitles), information as to language etc. An SDRAM 10 is a memory temporarily storing data when the control portion 6 performs an operation such as data processing.

According to this embodiment, the television 1 further comprises a scaler 11 adjusting the images received from the external apparatus to coincide with the size of a display section of the display portion 4. This scaler 11, storing a circuit capable of detecting the video signal from the external apparatus, can detect the presence or absence of the video signal from the external apparatus. The scaler 11 is so formed as to detect the video signal simultaneously with auto-preset processing for automatically registering channels corresponding to the broadcast signals received by the tuner unit 2. The external input terminals 3a from which video signals are detected are registered in the EEPROM 8 as input modes having the video signals whose images can be displayed on the display portion 4.

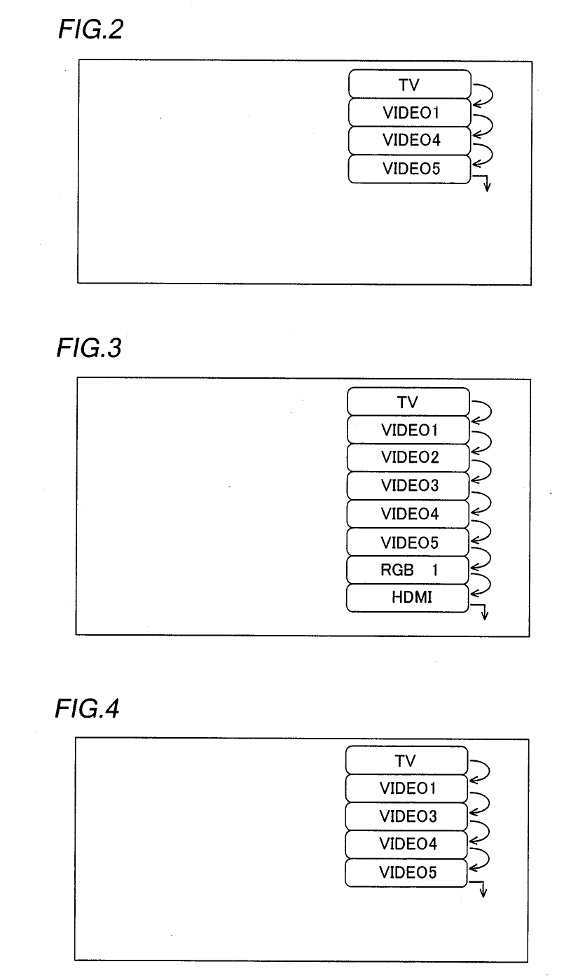

The structure of an input mode switching screen is now described with reference to FIGS. 2 to 4.

The display portion 4 displays the input mode switching screen, so that the user can switch and select a desired input mode by performing the prescribed operation on the input portion 7 or the remote control 20. On this input mode switching screen, the user can switch and select the video signal to be input in the display portion 4 from among the video signals received from the broadcast stations and those received from the external apparatuses connected to the plurality of external input terminals 3a of the external input substrate 3 respectively. The user can sequentially switch the input modes on this input mode switching screen in the so-called toggle system by pushing down a prescribed button of the input portion 7 or the remote control 20. More specifically, the input mode switching screen is so formed as to switch the selected input mode along arrow every time the user pushes down the prescribed button, as shown in FIGS. 2 to 4. Further, the input mode switching screen is so formed as to change the color, the shape etc. of the selected input mode. Thus, the user can visually recognize the selected input mode. According to this embodiment, the display portion 4 is so formed as to decide the input mode and display images on the basis of the video signal received from the external apparatus connected to the external input terminal 3a corresponding to the decided input mode when the user does not switch the input mode for 3 seconds in the state selecting this input mode on the input mode switching screen.

According to this embodiment, the display portion 4 is so formed as to display only the input modes (registered input mode list) first registered in the aforementioned auto-preset processing when the user directs the display portion 4 to display the input mode switching screen by the prescribed operation, as shown in FIG. 2. In other words, the display portion 4 displays only input modes (registered input modes) corresponding to external input terminals 3a connected with external apparatuses from which video signals are detected, without displaying input modes (unregistered input modes) corresponding to external input terminals 3a connected with external apparatuses from which no video signals are detected. The display portion 4 is so formed as to regularly display an input mode (“TV” in FIG. 2) corresponding to the video signals received from the broadcast stations. The registered input modes and the unregistered input modes are examples of the “first input mode” and the “second input mode” in the present invention respectively.

If the user does not select the input mode from among the registered input modes shown in FIG. 2, the display portion 4 selectably displays all input modes (standard input mode list) including the unregistered input modes, as shown in FIG. 3. According to this embodiment, the display portion 4 selectably displays all input modes (standard input mode list) when the user further switches the input mode in a state selecting the terminal input mode (“VIDEO5” in FIG. 2) from among the registered input modes shown in FIG. 2. If the user selects and decides an input mode (“VIDEO3” in FIG. 3, for example) other than the registered input modes on the standard input mode list, this input mode is newly registered as a registered input mode. In this case, the user directs the display portion 4 to display the input mode switching screen, so that the display portion 4 displays the newly registered input mode (“VIDEO3”) on the registered input mode list as shown in FIG. 4, in addition to the registered input modes shown in FIG. 2.

When the user further switches the input mode in a state selecting the terminal input mode (“HDMI” in FIG. 3) on the standard input mode list shown in FIG. 3, the display portion 4 displays the registered input modes (registered input mode list) shown in FIG. 2 again.

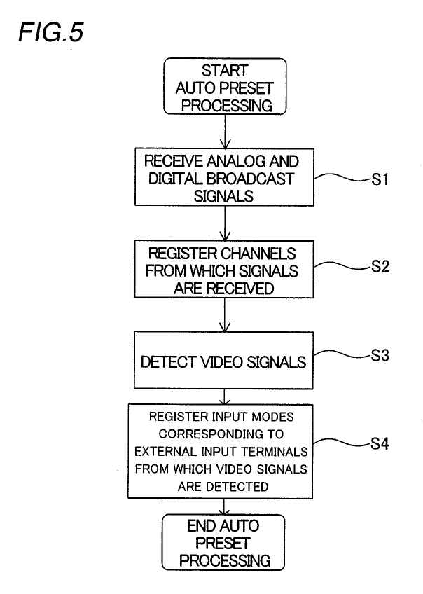

The input mode registering operation of the television 1 according to this embodiment is now described with reference to FIG. 5.

In the television 1 according to this embodiment, the auto-preset processing is first performed upon power supply. More specifically, the tuner unit 2 receives analog broadcast signals and digital broadcast signals transmitted from the broadcast stations at a step S1 shown in FIG. 5. At a step S2, the frequencies of the received broadcast signals and the channels corresponding to these signals are automatically combined with each other, and the combinations are registered in the EEPROM 8.

According to this embodiment, the video signals received from the external apparatuses are thereafter detected at a step S3. More specifically, the AV switch 5 sequentially switch and connect the plurality of external input terminals 3a to the scaler 11, so that a synchronous circuit stored in the scaler 11 detects the presence or absence of video signals from the connected external input terminals 3a. At a step S4, the EEPROM 8 registers the input modes corresponding to the external input terminals 3a from which video signals are detected as input modes having video signals whose images can be displayed on the display portion 4.

The information of the input modes registered in the EEPROM 8 is reset every power supply (auto-preset processing), so that the synchronous circuit detects the presence or absence of current video signals from the external apparatuses and the EEPROM 8 registers the current input modes.

The input modes are registered in the television 1 according to this embodiment in the aforementioned manner.

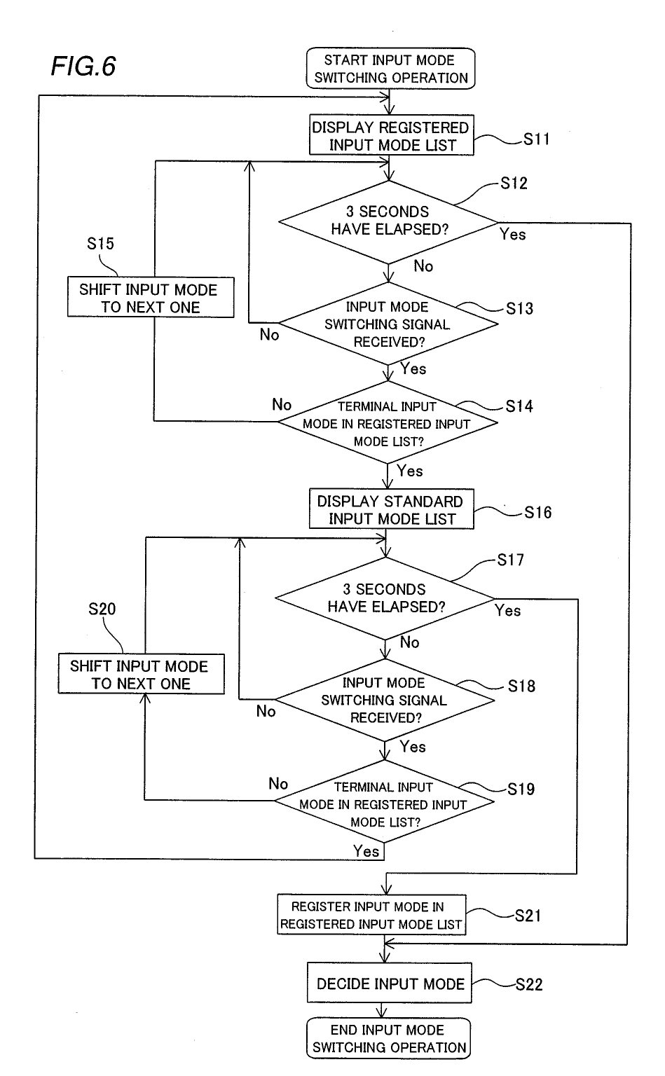

FIG. 6 is a flow chart for illustrating an input mode switching operation of the television 1 according to this embodiment. The input mode switching operation of the television 1 according to this embodiment is now described with reference to FIGS. 2 to 6.

In order to switch the input mode, the user first performs the prescribed operation, so that the display portion 4 displays the input mode switching screen. At a step S11 shown in FIG. 6, the display portion 4 displays the input modes (registered input mode list) registered at the aforementioned step S4 (see FIG. 5), as shown in FIG. 2. At this time, the television 1 is in a state selecting the input mode having been selected before the display portion 4 displays the input mode switching screen. In this state, the control portion 6 determines whether or not 3 seconds have elapsed at a step S12. If determining that 3 seconds have elapsed at the step S12, the control portion 6 decides the selected input mode and terminates the input mode switching operation.

If determining that 3 seconds have not yet elapsed in the state where the input mode is selected at the step S12, on the other hand, the control portion 6 determines whether or not an input mode switching signal is received (whether or not the user instructs the television 1 to switch the input mode through the input portion 7 or the remote control 20) at a step S13. If determining that no input mode switching signal is received at the step S13, the control portion 6 returns to the step S12 and repeats the processing at the steps S12 and S13 until 3 seconds elapse. If determining that the input mode switching signal is received at the step S13, on the other hand, the control portion 6 determines whether or not the input mode selected from the registered input mode list is the terminal input mode at a step S14. If determining that the selected input mode is not the terminal input mode, the control portion 6 shifts the input mode to the next one at a step S15, and returns to the step S12. More specifically, the control portion 6 shifts the input mode to the next input mode “VIDEO4” if the nonterminal input mode “VIDEO1” is selected in FIG. 2. Thereafter the control portion 6 repeats the steps S12 to S15 until the terminal input mode is selected.

If determining that the selected input mode is the terminal input mode at the step S14, on the other hand, the control portion 6 controls the display portion 4 to display the standard input mode shown in FIG. 3 at a step S16. More specifically, the display portion 4 displays the standard input mode list shown in FIG. 3 and the first input mode (“TV” in FIG. 3) is selected due to the input mode switching signal if the terminal input mode “VIDEO5” has been selected in FIG. 2.

Thereafter the control portion 6 determines whether or not 3 seconds have elapsed at a step S17. If determining that 3 seconds have not yet elapsed at the step S17, the control portion 6 determines whether or not another input mode switching signal is received at a step S18. If determining that no input mode switching signal is received at the step S18, the control portion 6 returns to the step S17 and repeats the processing at the steps S17 and S18 until 3 seconds elapse. If determining that another input mode switching signal is received at the step S18, on the other hand, the control portion 6 determines whether or not the input mode selected from the standard input mode list is the terminal input mode at a step S19. If determining that the selected input mode is not the terminal input mode at the step S19, the control portion 6 shifts the input mode to the next one at a step S20, and returns to the step S17. More specifically, the control portion 6 shifts the input mode to the next input mode “VIDEO2” if the nonterminal input mode “VIDEO1” is selected in FIG. 3. Thereafter the control portion 6 repeats the steps S17 to S20 until the terminal input mode is selected.

If determining that the selected input mode is the terminal input mode at the step S19, on the other hand, the control portion 6 controls the display portion 4 to display the registered input mode list shown in FIG. 2 at the step S11. More specifically, the display portion 4 displays the registered input mode list shown in FIG. 2 and the initial input mode (“TV” in FIG. 2) is selected due to the input mode switching signal, and the control portion 6 repeats the aforementioned processing if determining that the terminal input mode “HDMI” is selected in FIG. 3.

If the control portion 6 determines that 3 seconds have elapsed at the step S17, on the other hand, the EEPROM 8 registers the selected input mode as the registered input mode at a step S21. Thereafter the control portion 6 decides the selected input mode at a step S22, and terminates the input mode selecting operation.

According to this embodiment, as hereinabove described, the display portion 4 selectably displays the input modes (registered input mode list) corresponding to the external input terminals 3a from which the video signals are detected by the scaler 11 so that the display portion 4 can display only the input modes corresponding to the detected video signals while automatically skipping input modes corresponding to undetected video signals without requiring the user to perform separate setting, whereby the convenience of the user can be improved. Further, the display portion 4 selectably displays the input modes (registered input mode list) corresponding to the external input terminals 3a from which the video signals are detected by the scaler 11 while selectably displaying the standard input mode list when the user does not select the input mode from the registered input mode list, whereby the user can also select an input mode corresponding to an external input terminal 3a from which no signal is detected since no external apparatus is connected thereto or the external apparatus connected thereto is in an OFF-state. Thus, the user can select the input mode corresponding to this external input terminal 3a without connecting an ON-state external apparatus to the external input terminal 3a.

According to this embodiment, as hereinabove described, the display portion 4 newly registers the input mode selected from the standard input mode list as the registered input mode, whereby the same can first display the newly registered input mode as the registered input mode when the user changes the input mode after the registration.

According to this embodiment, as hereinabove described, the EEPROM 8 registers the input modes corresponding to the external input terminals 3a connected to the external apparatuses from which video signals are detected as the registered input modes when registering the channels of the broadcast signals received by the tuner unit 2 (auto-preset processing), so that the input modes corresponding to the external apparatuses such as the cable TV tuner 102 generally connected to the television 1 in an ON-state can be substantially simultaneously registered in registration of the channels. Thus, the user can watch images received from the external apparatus such as the cable TV tuner 102 immediately after registration of the channels.

According to this embodiment, as hereinabove described, the scaler 11 detects the presence or absence of the video signals from the external apparatuses, whereby the video signals from the external apparatuses can be detected without separately providing a circuit for detecting the video signals from the external apparatuses.

Although the present invention has been described and illustrated in detail, it is clearly understood that the same is by way of illustration and example only and is not to be taken by way of limitation, the spirit and scope of the present invention being limited only by the terms of the appended claims.

For example, while the display portion 4 selectably displays all input modes when no registered input mode is selected in the aforementioned embodiment, the present invention is not restricted to this but the display portion 4 may alternatively be so formed as to display only the input modes, other than the registered input modes, corresponding to the external input terminals 3a connected to the external apparatuses from which no video signals are detected.

While the control portion 6 decides the input mode when the user does not switch the input mode in 3 seconds in the state selecting this input mode on the input mode switching screen in the aforementioned embodiment, the present invention is not restricted to this but the user may alternatively decide the input mode by pushing down a decision button (not shown) or the like.

While the scaler 11 detects the presence or absence of the video signals from the external apparatuses in the auto-preset processing in the aforementioned embodiment, the present invention is not restricted to this but the scaler 11 may alternatively detect the presence or absence of the video signals from the external apparatuses at any time.

While the personal computer 100, the DVD player 101 and the cable TV tuner 102 are employed as the exemplary external apparatuses in the aforementioned embodiment, the present invention is not restricted to this but the external apparatuses include apparatuses such as video-game software, a video tape recorder and a laser-disk player outputting video signals.

While the display portion 4 displays the standard input mode list when the user instructs the display portion 4 to switch the input mode in the state selecting the terminal input mode in the registered input mode list in the aforementioned embodiment, the present invention is not restricted to this but the user may alternatively direct the display portion 4 to switch and display the registered input mode list and the standard input mode list by performing the prescribed operation on the input portion 7 or the remote control 20.

While the scaler 11 detects the video signals from the external apparatuses in the aforementioned embodiment, the present invention is not restricted to this but the scaler 11 may alternatively detect other signals such as sound signals or control signals.

While the display portion 4 is formed by an LCD in the aforementioned embodiment, the present invention is not restricted to this but the display portion 4 may alternatively be formed by a PDP (plasma display panel) or a CRT (cathode ray tube).

What is claimed is:

1. A display comprising:
a plurality of external input connection portions connected with a plurality of external apparatuses respectively;
a detection portion detecting signals from said external apparatuses connected to said external input connection portions;
a display portion selectably displaying input modes corresponding to said plurality of external input connection portions respectively; and
a control portion controlling said display portion to display an image on the basis of a signal of said external input connection portion corresponding to selected said input mode, wherein
said control portion is so formed as to control said display portion to selectably display a first input mode corresponding to said external input connection portion from which a signal is detected by said detection portion and to selectably display a second input mode corresponding to at least said external input connection portion from which no signal is detected by said detection portion when said first input mode is not selected.

2. The display according to claim 1, wherein
said control portion is so formed as to control said display portion to selectably display said first input mode corresponding to said external input connection portion from which a signal is detected by said detection portion and to selectably display both of said first input mode and said second input mode corresponding to said external input connection portion from which no signal is detected by said detection portion when said first input mode is not selected.

3. The display according to claim 2, further comprising an input portion allowing the user to switch and select the input mode, wherein
said control portion is so formed as to control said display portion to display both of said first input mode and said second input mode so that the user can successively switch and select said first input mode or said second input mode when the user further switches the input mode in a state selecting terminal said first input mode.

4. The display according to claim 1, further comprising a registration portion registering said first input mode, wherein
said control portion is so formed as to register selected said second input mode as said first input mode when said second input mode is selected.

5. The display according to claim 1, further comprising a receiving portion receiving a broadcast signal transmitted from a broadcast station, wherein
said control portion is so formed as to register said first input mode in said registration portion when registering a channel corresponding to said broadcast signal received by said receiving portion upon power supply to said display.

6. The display according to claim 5, wherein
said control portion is so formed as to control said detection portion to detect said signals from said external apparatuses connected to said external input connection portions and to control said registration portion to register said first input mode every time power is supplied to said display.

7. The display according to claim 5, wherein
said control portion is so formed as to control said display portion to display an input mode corresponding to said receiving portion of said display as said first input mode.

8. The display according to claim 1, further comprising an input portion allowing the user to switch and select the input mode, wherein
said control portion is so formed as to control said display portion to display an image on the basis of a video signal from said external apparatus connected to said external input connection portion corresponding to an input mode selected upon a lapse of a prescribed time when a button of said input portion is not operated for at least said prescribed time.

9. The display according to claim 1, further comprising a scaler adjusting said image to coincide with the size of a display section of said display portion, wherein
said scaler is so formed as to function also as said detection portion detecting said signals from said external apparatuses.

10. A television comprising:
a plurality of external input connection portions connected with a plurality of external apparatuses respectively;
a detection portion detecting signals from said external apparatuses connected to said external input connection portions;
a display portion selectably displaying input modes corresponding to said plurality of external input connection portions respectively; and
a control portion controlling said display portion to display an image on the basis of a signal of said external input connection portion corresponding to selected said input mode, wherein
said control portion is so formed as to control said display portion to selectably display a first input mode corresponding to said external input connection portion from which a signal is detected by said detection portion and to selectably display a second input mode corresponding to at least said external input connection portion from which no signal is detected by said detection portion when said first input mode is not selected.

11. The television according to claim 10, wherein
said control portion is so formed as to control said display portion to selectably display said first input mode corresponding to said external input connection portion from which a signal is detected by said detection portion and to selectably display both of said first input mode and said second input mode corresponding to said external input connection portion from which no signal is detected by said detection portion when said first input mode is not selected.

12. The television according to claim 11, further comprising an input portion allowing the user to switch and select the input mode, wherein
said control portion is so formed as to control said display portion to display both of said first input mode and said second input mode so that the user can successively switch and select said first input mode or said second input mode when the user further switches the input mode in a state selecting terminal said first input mode.

13. The television according to claim 10, further comprising a registration portion registering said first input mode, wherein
said control portion is so formed as to register selected said second input mode as said first input mode when said second input mode is selected.

14. The television according to claim 10, further comprising a receiving portion receiving a broadcast signal transmitted from a broadcast station, wherein
said control portion is so formed as to register said first input mode in said registration portion when registering a channel corresponding to said broadcast signal received by said receiving portion upon power supply to said television.

15. The television according to claim 14, wherein
said control portion is so formed as to control said detection portion to detect said signals from said external apparatuses connected to said external input connection portions and to control said registration portion to register said first input mode every time power is supplied to said television.

16. The television according to claim 14, wherein
said control portion is so formed as to control said display portion to display an input mode corresponding to said receiving portion of said television as said first input mode.

17. The television according to claim 10, further comprising an input portion allowing the user to switch and select the input mode, wherein
said control portion is so formed as to control said display portion to display an image on the basis of a video signal from said external apparatus connected to said external input connection portion corresponding to an input mode selected upon a lapse of a prescribed time when a button of said input portion is not operated for at least said prescribed time.

18. The television according to claim 10, further comprising a scaler adjusting said image to coincide with the size of a display section of said display portion, wherein
said scaler is so formed as to function also as said detection portion detecting said signals from said external apparatuses.
